(19) United States
(12) Patent Application Publication
(10) Pub. No.: US 2015/0071083 A1
(43) Pub. Date: Mar. 12, 2015

(54) ADAPTING A SYSTEM BANDWIDTH TO BE USED BY A USER EQUIPMENT FOR AN UPLINK COMMUNICATION CHANNEL

(71) Applicants: Alfredo Rocchetti, Munich (DE); Markus Reinhardt, Neu-Ulm (DE)

(72) Inventors: Alfredo Rocchetti, Munich (DE); Markus Reinhardt, Neu-Ulm (DE)

(73) Assignee: Nokia Siemens Networks OY, Espoo (FI)

(21) Appl. No.: 14/399,284

(22) PCT Filed: May 11, 2012
(86) PCT No.: PCT/EP2012/058810

§ 371 Date: Nov. 6, 2014

(51) Int. Cl. H04W 72/04; H04W 24/02; H04L 1/00

(52) U.S. Cl. CPC H04W 72/044; H04L 1/0003; H04W 24/02
USPC 370/242

(57) ABSTRACT

Described is a method for adapting a system bandwidth to be used by a user equipment for an uplink communication channel for an uplink communication between the user equipment and a base station within a cell of a cellular network system, wherein the cell is served by the base station, wherein the user equipment is adapted to use a predefined system bandwidth for the uplink communication. The method includes determining an actual block error rate of the uplink communication channel, comparing the actual block error rate with a predefined threshold, and adapting the predefined system bandwidth based on the result of the comparison.

### FIELD OF THE INVENTION

The present invention relates to the field of cellular communication networks and in particular to link adaptation in the uplink direction.

### BACKGROUND OF THE INVENTION

In cellular network systems, the conditions of communication links or channels between different network elements, for example user equipments (UEs) and base stations, may change from time to time. Thus, link adaptation is used for adapting the communication between user equipments and base stations considering the change conditions. This may be done inter alia by changing the modulation and/or coding scheme (MCS), for instance by increasing or lowering the MCS level.

Current link adaptation methods target at lowering of the used bandwidth per UE and increasing of the MCS level when the UE is in a bad radio frequency condition resulting from power limitations. This may lead, especially in low load scenarios, to a power inefficient transmission which indeed contradicts the Shannon theorem which says that for a given data rate it is more power efficient to use low MCS levels and to increase the transmission bandwidth instead of the contrary.

In view of the above-described situation, there exists a need for an improved technique that provides a cellular communication system being able to provide efficient and improved link adaptation.

### SUMMARY OF THE INVENTION

This need may be met by the subject matter according to the independent claims. Advantageous embodiments of the herein disclosed subject matter are described by the dependent claims.

According to a first aspect of the invention, there is provided a method for adapting a system bandwidth to be used by a user equipment for an uplink communication channel for an uplink communication between the user equipment and a base station within a cell of a cellular network, wherein the cell is served by the base station, wherein the user equipment is adapted to use a predefined system bandwidth for the uplink communication. The method comprises determining an actual block error rate of the uplink communication channel, comparing the actual block error rate with a predefined threshold, and adapting the predefined system bandwidth based on the result of the comparison.

This aspect may be based on the idea to use the block error rate as a robust and accurate measurement and basis for decision of appropriate bandwidths.

In current system concepts, power headroom report (PHR) has been used for adaptation methods to determine the to-be-used modulation and coding scheme (MCS) and bandwidth. Such methods may reduce the bandwidth or numbers of allocated physical resource blocks (PRBs) per user equipment (UE) proportional to a missing transmit power at a UE, even in a low loaded system. PHR corresponds to a rough path-loss estimation. As such methods target at lowering the used bandwidth per UE and increasing the MCS level when the UE is in a bad RF condition, this may lead, especially in low load scenarios, to a power inefficient transmission which indeed contradicts the Shannon theorem according to which, for a given data rate, it is more power efficient to use low MCS levels and to increase the transmission bandwidth instead of the contrary.

The herein described method does not base the decision about the bandwidth only to PHR as feedback for the decision process, but introduce the utilization of the block error rate (BLER) measurements as main criterion for determination of the to be used bandwidth for each UE.

BLER estimation is a very robust and accurate measurement in contrast to the rough PHR measurement which is based on a rough path-loss estimation only. BLER is defined as the ratio of the number of erroneous blocks received to the total number of blocks sent. An erroneous block is defined as a Transport Block, the cyclic redundancy check (CRC) of which is wrong.

The base station may be any kind of base station or eNodeB (eNB) being able to provide the above mentioned functionalities. The user equipment may be a regular LTE device being able to communicate with the base station.

The total bandwidth available for transmission between UEs and the base station may be shared for uplink user specific data transmission and common signaling transmission. Furthermore the total bandwidth available for uplink data transmission in a cell may be used simultaneously for uplink transmission of the data of multiple UEs allocated in the cell ((“UL shared communication channel”). The split of the shared bandwidth resource is defined via signaling. “Uplink shared communication channel” in this context may refer to a physical uplink shared channel (PUSCH). The allocation of the bandwidth may be controlled and signaled to the UE via physical downlink control channel (PDCCH).

According to a further embodiment of the invention, the method further comprises determining an actual modulation and coding scheme level used for the uplink communication, comparing the actual modulation and coding scheme level with a predefined minimum threshold for the modulation and coding scheme level, and adapting the predefined system bandwidth based on the result of the comparison of the actual block error rate with a predefined threshold and based on the result of the comparison of the actual modulation and coding scheme level with a predefined minimum threshold for the modulation and coding scheme level.

According to the herein described method, the MCS level may be considered when deciding about the adaptation of the bandwidth. In particular, a minimum MCS level may be defined as a decision criterion.

“MCS level” in this context may refer to a modulation and coding scheme of a specific order. A high MCS level corresponds to a high order modulation and high code rate, a low MCS level corresponds to a low order modulation and low code rate. The predefined minimum MCS level may correspond to the lowest order modulation and lowest code rate which can be used or which is appropriate for the used system.

According to a further embodiment of the invention, if the actual block error rate is below the predefined threshold, adapting the predefined system bandwidth corresponds to increasing the predefined system bandwidth.

A low BLER (i.e., the quality of the link is good as there are only few erroneous transmitted blocks) shows that power is available, and thus, the bandwidth may be increased.

According to a further embodiment of the invention, the method further comprises determining an actual modulation and coding scheme level used for the uplink communication, comparing the actual modulation and coding scheme level with a predefined minimum threshold for the modulation and coding scheme level, and increasing the predefined system bandwidth, if the actual modulation and coding scheme level is above the predefined minimum threshold.

As described above, a lower BLER in the transmission shows that power is available and then the bandwidth may be increased if the MCS level is not yet at minimum. This may lead to a power efficient transmission with maximized bandwidth usage. In particular, the Shannon theorem may thus be fulfilled, according to which it is more power efficient, for a given data rate, to use low MCS levels and to increase the transmission bandwidth instead of the contrary.

According to a further embodiment of the invention, if the actual block error rate is above the predefined threshold, adapting the predefined system bandwidth corresponds to reducing the predefined system bandwidth.

A high BLER (i.e., the quality of the link is bad as there are many erroneous transmitted blocks) and low MCS level shows that there is no power available and MCS cannot be lowered, and thus, the bandwidth might have to be reduced.

According to a further embodiment of the invention, the method further comprises determining an actual modulation and coding scheme level used for the uplink communication, comparing the actual modulation and coding scheme level with a predefined minimum threshold for the modulation and coding scheme level, and reducing the predefined system bandwidth, if the actual modulation and coding scheme level is equal or below the predefined minimum threshold.

As described above, a high BLER in the transmission shows that the link quality is in a bad condition. In such a case, the MCS level may be reduced. If the MCS level is already at a minimum predefined level, then the bandwidth should be reduced.

According to a further embodiment of the invention, a communication channel between the user equipment and the base station is divided into a plurality of physical resource blocks and wherein the predefined system bandwidth corresponds to a predefined number of physical resource blocks of the plurality of resource blocks being allocated to the uplink shared communication channel.

A communication channel may be divided into a plurality of sub-carriers. Each user is allocated a specific number of subcarriers for a specified time slot. These are referred to as physical resource blocks (PRBs) in the LTE specifications. PRBs thus are identified by two factors—time and frequency. Base stations (eNBs) are responsible for the resource scheduling to the users. The bandwidth corresponds to the number of PRBs being allocated to a user.

According to a further embodiment of the invention, the predefined number of physical resource blocks being allocated to the uplink communication channel is adaptable based on the results of the comparisons.

Increasing or reducing the bandwidth allocated for a user transmission corresponds to increasing or reducing the number of PRBs being allocated to a user.

According to a further embodiment of the invention, the block error rate is determined based on measurements performed by the base station.

The UE may perform some measurements and report the results of the measurements to the base station. The base station may determine the actual BLER based on the received results via a cyclic redundancy check method.

According to a further embodiment of the invention, adapting the predefined system bandwidth is further based on a power headroom report measurement.

A first, rough, adaptation of the bandwidth may be performed on the power headroom report (PHR) measurement. A second, more accurate, adaptation of the bandwidth may be performed based on BLER measurements, in some cases in combination with the actual MCS level.

Power Headroom (PH), expressed in decibels, is defined as the difference between the nominal UE maximum transmit power and the estimated power for the Physical Uplink Shared Channel (PUSCH) transmission. It may be the power that can be added to UL data transmission by the UE if the UE moves toward the cell edge or requires a service with a higher (guaranteed) bit rate before the UE power is reaching the upper limit

According to a further embodiment of the invention, the method further comprises adapting the modulation and coding scheme used for the uplink communication based on an outer loop link adaptation.

According to a second aspect of the invention, a base station is provided for adapting a system bandwidth to be used by a user equipment for an uplink communication channel for an uplink communication between the user equipment and the base station within a cell of a cellular network. The cell is served by the base station, wherein the user equipment is adapted to use a predefined system bandwidth for the uplink communication. The base station comprises a determination unit being adapted to determine an actual block error rate of the uplink communication channel, a comparison unit being adapted to compare the actual block error rate with a predefined threshold, and an adaptation unit being adapted to adapt the predefined system bandwidth based on the result of the comparison.

The base station may be any type of access point or point of attachment, which is capable of providing a wireless access to a cellular network system. Thereby, the wireless access may be provided for a user equipment or for any other network element, which is capable of communicating in a wireless manner. The base station may be an eNodeB, Home eNodeB, or any other kind of access point.

The base station may comprise a receiving unit, in short, a receiver, which may be a common receiver as known by a skilled person. The base station may also comprise a transmitting unit, in short, a transmitter. The receiver and the transmitter may be implemented as one single unit, for example as a transceiver. The transceiver or the receiving unit and the transmitting unit may be adapted to communicate with a further base station or the user equipment via an antenna.

The determination unit, the comparison unit and the adaptation unit may be implemented as single units or may be one unit being implemented for example as part of a standard control unit, like a CPU or a microcontroller.

According to a third aspect of the invention, there is provided a user equipment being adapted to communicate with a base station as described above.

The user equipment (UE) may be any type of communication end device, which is capable of connecting with the described base station. The UE may be in particular a cellular mobile phone, a Personal Digital Assistant (PDA), a notebook computer, a printer and/or any other movable communication device. In particular, in the context of this application, a UE may be any kind of communication device, for example a smart phone, being able to perform transmissions based on the configuration as provided by the base station.

The user equipment may comprise a receiving unit or receiver which is adapted for receiving signals from the base stations. The user equipment may comprise a transmitting unit for transmitting signals. The transmitting unit may be a transmitter as known by a skilled person. The receiver and the transmitting unit may be implemented as one single unit, for example as a transceiver. The transceiver or the receiver and the transmitting unit may be adapted to communicate with the base stations via an antenna.

The user equipment may further comprise a control unit being adapted to control transmissions. The control unit may be implemented as a single unit or may be implemented for example as part of a standard control unit, like a CPU or a microcontroller.

According to a fourth aspect of the invention, a cellular network system for adapting a system bandwidth to be used by a user equipment for an uplink communication channel for an uplink communication between the user equipment and a base station is provided, wherein the cellular network system comprises at least one base station as described above.

Generally herein, the method and embodiments of the method according to the first aspect may include performing one or more functions described with regard to the second, third or fourth aspect or an embodiment thereof. Vice versa, the base station, user equipment or cellular network system and embodiments thereof according to the second, third and fourth aspect may include units or devices for performing one or more functions described with regard to the first aspect or an embodiment thereof.

According to a fifth aspect of the herein disclosed subject-matter, a computer program for adapting a system bandwidth to be used by a user equipment for an uplink communication channel for an uplink communication between the user equipment and a base station, is provided, the computer program being adapted for, when executed by a data processor assembly, controlling the method as set forth in the first aspect or an embodiment thereof.

As used herein, reference to a computer program is intended to be equivalent to a reference to a program element and/or a computer readable medium containing instructions for controlling a computer system to coordinate the performance of the above described method.

The computer program may be implemented as computer readable instruction code by use of any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions.

The herein disclosed subject matter may be realized by means of a computer program respectively software. However, the herein disclosed subject matter may also be realized by means of one or more specific electronic circuits respectively hardware. Furthermore, the herein disclosed subject matter may also be realized in a hybrid form, i.e. in a combination of software modules and hardware modules.

In the above there have been described and in the following there will be described exemplary embodiments of the subject matter disclosed herein with reference to a cellular network system, a base station, a user equipment and a method of adapting a system bandwidth to be used by a user equipment for an uplink communication channel for an uplink communication between the user equipment and a base station. It has to be pointed out that of course any combination of features relating to different aspects of the herein disclosed subject matter is also possible. In particular, some embodiments have been described with reference to apparatus type embodiments whereas other embodiments have been described with reference to method type embodiments. However, a person skilled in the art will gather from the above and the following description that, unless other notified, in addition to any combination of features belonging to one aspect also any combination between features relating to different aspects or embodiments, for example even between features of the apparatus type embodiments and features of the method type embodiments is considered to be disclosed with this application.

The aspects and embodiments defined above and further aspects and embodiments of the present invention are apparent from the examples to be described hereinafter and are explained with reference to the drawings, but to which the invention is not limited.

### BRIEF DESCRIPTION OF THE DRAWINGS

FIG. 1 shows a cellular network system according to an exemplary embodiment of the invention.

FIG. 2 shows an adaptation method according to an exemplary embodiment of the invention.

FIG. 3 shows a base station and a user equipment within a cellular network system according to an exemplary embodiment of the invention.

It is noted that in different figures, similar or identical elements are provided with the same reference signs.

### DETAILED DESCRIPTION

In the following, embodiments of the herein disclosed subject matter are illustrated with reference to the drawings and reference to aspects of current standards, such as LTE. However, such reference to current standards is only exemplary and should not be considered as limiting the scope of the claims.

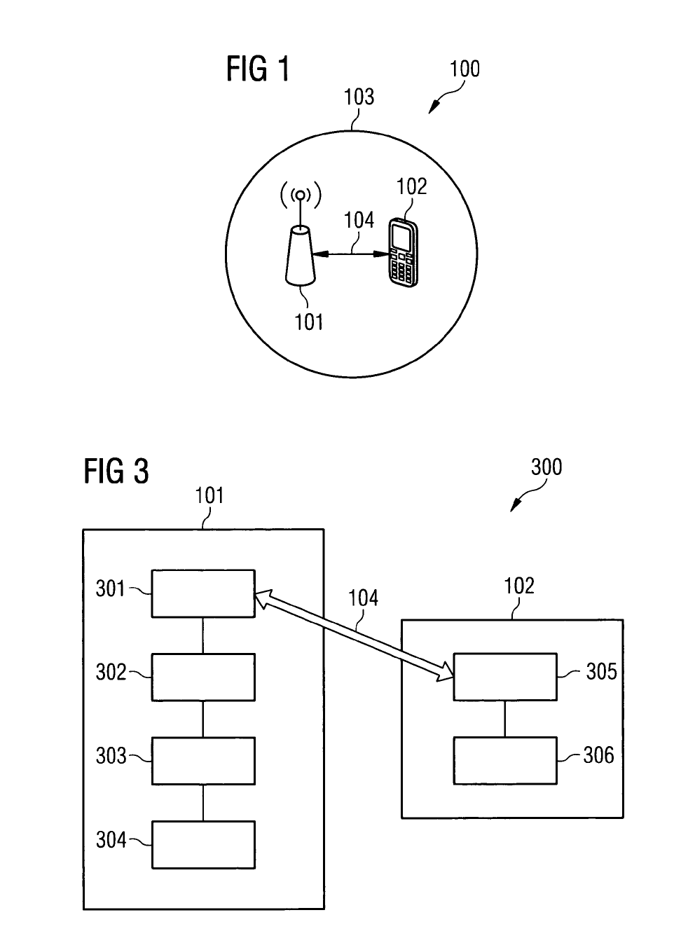

FIG. 1 shows a cellular network system 100 according to an exemplary embodiment. The cellular network system comprises at least one cell 103. A base station 101 serves this cell. A user equipment 102 is served by the base station.

The base station 101 and the user equipment (UE) 102 are adapted to communicate via a communication channel. A part of the communication channel is allocated to uplink communication, as an uplink communication channel 104. The base station 101 is adapted for adapting a system bandwidth to be used by the user equipment 102 for the uplink communication channel 104 for an uplink communication between the user equipment 102 and the base station 101 within the cell 103 of the cellular network system 100. The cell 103 is served by the base station 101. The user equipment 102 is adapted to use a predefined system bandwidth for the uplink communication.

According to the herein described method and system, the base station 101 determines an actual block error rate of the uplink communication channel 104. This may be done based on measurements from the UE 102.

The base station 101 then compares the actual block error rate with a predefined threshold, and adapts the predefined system bandwidth based on the result of the comparison.

This method and system is based on link adaptation in an OFDMA based uplink (UL) transmission system. Current link adaptation methods target at lowering of the used bandwidth per UE and increasing of the MCS level when the UE is in bad radio frequency condition resulting from power limitations. This may lead, especially in low load scenarios, to a power inefficient transmission which indeed contradicts the Shannon theorem which says that for a given data rate it is more power efficient to use low MCS levels and to increase the transmission bandwidth instead of the contrary).

In current system concepts, only power headroom report (PHR) based adaptation methods are used to determine the to-be-used modulation and coding scheme (MCS) and bandwidth and to reduce the number of allocated physical resource blocks (PRBs) per UE proportional to the missing transmit power at the UE even in a low loaded system.

The herein described method and system will use no more only the PHR as feedback for the decisional process, but introduce the utilization of the BLER measurements as main criterion for determination of the upper limit of the to be used bandwidth for each UE. BLER estimation is a very robust and accurate measurement in contrast to the rough PHR measurement which is based on a rough path-loss estimation only.

For instance, two main cases may be used depending on the determined BLER measurements and the currently used MCS level (it should be noted that these main cases are only exemplary and that also other decision criterions may be introduced):
1. A lower BLER in the transmission shows that power is available and then the PRBs are increased if the MCS level is not yet at a minimum threshold. This may lead to a power efficient transmission with maximized PRB usage.
2. With a high BLER, the PRBs are only reduced if the MCS level is already at the minimum threshold.

The algorithm can be used periodically for each UE after the outer loop link adaptation algorithm (OLLA), which, together with the inner loop link adaptation algorithm, determines the MCS level.

This method and system may be implemented in the signal processing hardware dedicated to the radio resource management (RRM) algorithm for the UL path in a OFDMA system (like LTE). Introduction of the herein described BLER based algorithm may help in reaching better throughput and/or coverage performance in UL, in particular under special conditions like power limited conditions in a low loaded cell.

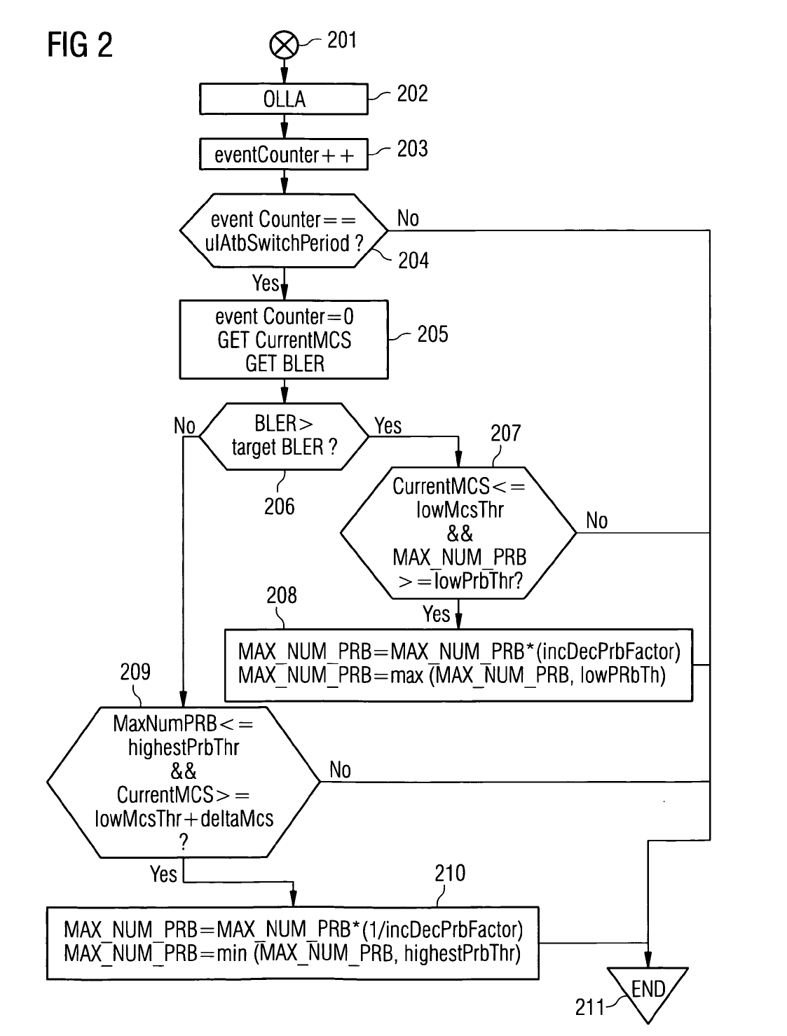

FIG. 2 shows an example for the method. After starting the method 201, OLLA 202 may be performed for determining an MCS level. An eventCounter may be increased afterwards, 203. Then, it may be determined whether the eventCounter is equal to an uplink Atb Switch Period (ulAtbSwitchPeriod), 204. If no, the method ends, 211, and can begin again at the start.

If yes, the eventCounter will be set to zero, 205. Further, the current/actual MCS level and the current/actual BLER will be retrieved, 205.

If the current BLER is above a target BLER (or threshold), 206, it will be determined whether the current MCS is equal to or below a minimum MCS threshold (lowMCSThr) and whether the maximum number of allocated PRBs (MAX_NUM_PRB) is equal to or above a minimum PRB threshold (lowPrbThr), 207. If no, the method ends, 211, and can being again at the start.

If yes, the allocated number of PRBs is set to a new value. The new value corresponds to the allocated number multiplied by a factor (incDecPrbFactor). This factor may be <1 so that the number of PRBs is reduced. Here, as the BLER is above a target value and the MCS is already very low, the number of PRBs might be need to be decreased as well. The factor decreases the number of PRBs at least by one, 208. The new value corresponds to a maximum for the PRBs based on the allocated number of PRBs and the minimum threshold value for the PRBs. After this, the method ends, 211, and can begin again at the start.

If the current BLER is equal to or below the target BLER (or threshold), 206, it will be determined whether the maximum number of allocated PRBs (MAX_NUM_PRB) is below a maximum PRB threshold (highestPrbThr) and whether the current MCS is equal to or above a minimum MCS threshold (lowMCSThr) plus a delta MCS value, 209. If no, the method ends, 211, and can being again at the start.

If yes, the allocated number of PRBs is set to a new value. The new value corresponds to the allocated number divided by a factor (i.e., multiplied with 1/incDecPrbFactor). Also in this case, the factor may be <1, thus, a division by the factor results in an increase of the number of PRBs. This may be desired because being under the target value for BLER means that there are good radio frequency (RF) conditions and therefore it might be needed to expand again to the maximum possible amount of allocatable PRBs before the MCS level is incremented again. The factor increases the number of PRBs at least by one. The new value corresponds to a minimum for the PRBs based on the allocated number of PRBs and the maximum threshold value for the PRBs. After this, the method ends, 211, and can begin again at the start.

FIG. 3 shows a cellular network system 300 according to an exemplary embodiment of the invention. The cellular network system comprises a base station 101 and a user equipment 102.

The base station 101 is adapted for adapting a system bandwidth to be used by the user equipment 102 for an uplink communication channel 104 for an uplink communication between the user equipment 102 and the base station 101. The user equipment 102 is adapted to use a predefined system bandwidth for the uplink communication.

The base station 101 comprises a determination unit 302, a comparison unit 303 and an adaptation unit 304. The determination unit 302, the comparison unit 303 and the adaptation unit 304 may be implemented for example as part of a standard control unit, like a CPU or a microcontroller, or may be implemented as a single unit.

The determination unit 302 is adapted to determine an actual block error rate of the uplink communication channel. This may be done based on measurements being performed by the user equipment 102.

The comparison unit 303 is adapted to compare the actual block error rate with a predefined threshold. For instance, the predefined threshold may be pre-determined based on any UE requirements or may be predefined by an operator.

The adaptation unit 304 is adapted to adapt the predefined system bandwidth based on the result of the comparison. The system bandwidth or number of PRBs may be increased or reduced based on the comparison. In some cases, the actual MCS level may also be considered for this decision.

The base station comprises a receiver as known by a skilled person. The base station may also comprise a transmitter. The receiver and the transmitter may be implemented as one single unit, for example as a transceiver 301 as shown in FIG. 3. The transceiver or the receiving unit and the transmitter may be adapted to communicate with a further base station (not shown) or the user equipment 102 via an antenna.

The base stations may be any type of access point or point of attachment, which is capable of providing a wireless access to a cellular network system. Thereby, the wireless access may be provided for the user equipment, or for any other network element, which is capable of communicating in a wireless manner. The base stations may be a NodeB, eNB, home NodeB or HeNB, or any other kind of access point.

The user equipment 102 (UE) may be any type of communication end device, which is capable of connecting with the described base station. The UE may be in particular a cellular mobile phone, a Personal Digital Assistant (PDA), a notebook computer, a printer and/or any other movable communication device.

The user equipment 102 may comprise a receiving unit or receiver which is adapted for receiving signals from the base station. The user equipment may comprise a transmitting unit for transmitting signals. The transmitting unit may be a transmitter as known by a skilled person. The receiver and the transmitting unit may be implemented as one single unit, for example as a transceiver 305. The transceiver or the receiver and the transmitting unit may be adapted to communicate with the base station via an antenna.

The user equipment may further comprise a control unit 306 for controlling and configuring transmissions based on information received from the base station. The control unit may be implemented as a single unit or may be implemented for example as part of a standard control unit, like a CPU or a microcontroller.

Having regard to the subject matter disclosed herein, it should be mentioned that, although some embodiments refer to a “base station”, “eNB”, etc., it should be understood that each of these references is considered to implicitly disclose a respective reference to the general term “network component” or, in still other embodiments, to the term “network access node”. Also other terms which relate to specific standards or specific communication techniques are considered to implicitly disclose the respective general term with the desired functionality.

It should further be noted that a base station as disclosed herein is not limited to dedicated entities as described in some embodiments. Rather, the herein disclosed subject matter may be implemented in various ways in various locations in the communication network while still providing the desired functionality.

According to embodiments of the invention, any suitable entity (e.g. components, units and devices) disclosed herein, e.g. the determination unit, are at least in part provided in the form of respective computer programs which enable a processor device to provide the functionality of the respective entities as disclosed herein. According to other embodiments, any suitable entity disclosed herein may be provided in hardware. According to other-hybrid-embodiments, some entities may be provided in software while other entities are provided in hardware.

It should be noted that any entity disclosed herein (e.g. components, units and devices) are not limited to a dedicated entity as described in some embodiments. Rather, the herein disclosed subject matter may be implemented in various ways and with various granularity on device level while still providing the desired functionality. Further, it should be noted that according to embodiments a separate entity (e.g. a software module, a hardware module or a hybrid module) may be provided for each of the functions disclosed herein. According to other embodiments, an entity (e.g. a software module, a hardware module or a hybrid module (combined software/hardware module)) is configured for providing two or more functions as disclosed herein.

It should be noted that the term “comprising” does not exclude other elements or steps. It may also be possible in further refinements of the invention to combine features from different embodiments described herein above. It should also be noted that reference signs in the claims should not be construed as limiting the scope of the claims.

### LIST OF REFERENCE SIGNS

100 Cellular network system
101 Base station
102 User equipment
103 Cell
104 Uplink communication channel
201 Start
202 OLLA
203 Counter increase
204 Decision
205 Getting actual values
206 Decision
207 Decision
208 Setting PRB number
209 Decision
210 Setting PRB number
211 End
300 Cellular network system
301 Transceiver of base station
302 Determination unit of base station
303 Comparison unit of base station
304 Adaptation unit of base station
305 Transceiver of user equipment
306 Control unit of user equipment

1. A method for adapting a system bandwidth to be used by a user equipment for an uplink communication channel for an uplink communication between the user equipment and a base station within a cell of a cellular network system, wherein the cell is served by the base station, wherein the user equipment is adapted to use a predefined system bandwidth for the uplink communication, the method comprising
determining an actual block error rate of the uplink communication channel,
comparing the actual block error rate with a predefined threshold, and
adapting the predefined system bandwidth based on the result of the comparison.

2. The method as set forth in claim 1, the method further comprising
determining an actual modulation and coding scheme level used for the uplink communication,
comparing the actual modulation and coding scheme level with a predefined minimum threshold for the modulation and coding scheme level, and
adapting the predefined system bandwidth based on the result of the comparison of the actual block error rate with a predefined threshold and based on the result of the comparison of the actual modulation and coding scheme level with a predefined minimum threshold for the modulation and coding scheme level.

3. The method as set forth in claim 1, wherein, if the actual block error rate is below the predefined threshold, adapting the predefined system bandwidth corresponds to increasing the predefined system bandwidth.

4. The method as set forth in claim 3, further comprising
determining an actual modulation and coding scheme level used for the uplink communication,
comparing the actual modulation and coding scheme level with a predefined minimum threshold for the modulation and coding scheme level, and
increasing the predefined system bandwidth, if the actual modulation and coding scheme level is above the predefined minimum threshold.

5. The method as set forth in claim 1, wherein, if the actual block error rate is above the predefined threshold, adapting the predefined system bandwidth corresponds to reducing the predefined system bandwidth.

6. The method as set forth in claim 5, further comprising
determining an actual modulation and coding scheme level used for the uplink communication,
comparing the actual modulation and coding scheme level with a predefined minimum threshold for the modulation and coding scheme level, and
reducing the predefined system bandwidth, if the actual modulation and coding scheme level is equal or below the predefined minimum threshold.

7. The method as set forth in claim 1, wherein a communication channel between the user equipment and the base station is divided into a plurality of physical resource blocks and wherein the predefined system bandwidth corresponds to a predefined number of physical resource blocks of the plurality of resource blocks being allocated to the uplink communication channel.

8. The method as set forth in claim 7, wherein the predefined number of physical resource blocks being allocated to the uplink communication channel is adaptable based on the results of the comparisons.

9. The method as set forth in claim 1, wherein the block error rate is determined based on measurements performed by the base station.

10. The method as set forth in claim 1, wherein adapting the predefined system bandwidth is further based on a power headroom report measurement.

11. The method as set forth in claim 1, the method further comprising adapting the modulation and coding scheme used for the uplink communication based on an outer loop link adaptation.

12. A base station for adapting a system bandwidth to be used by a user equipment for an uplink communication channel for an uplink communication between the user equipment and the base station within a cell of a cellular network system, wherein the cell is served by the base station, wherein the user equipment is adapted to use a predefined system bandwidth for the uplink communication, the base station comprising
a determination unit being adapted to determine an actual block error rate of the uplink communication channel,
a comparison unit being adapted to compare the actual block error rate with a predefined threshold, and
an adaptation unit being adapted to adapt the predefined system bandwidth based on the result of the comparison.

13. A user equipment, the user equipment being adapted to communicate with a base station as set forth in claim 12.

14. A cellular network system for adapting a system bandwidth to be used by a user equipment for an uplink communication channel for an uplink communication between the user equipment and a base station, the cellular network system comprising at least one base station as set forth in claim 12.
